(19) United States
(12) Patent Application Publication
(10) Pub. No.: US 2006/0000546 A1
(43) Pub. Date: Jan. 5, 2006

(54) Method for adhering waterproof tape

(75) Inventors: Pai-Jung Liao, Taipei (TW); Hsueh Sun, Taipei City (TW); Lu-Hsien Lee, Taipei City (TW); Yuan-Fu Lee, Taipei City (TW); Hung-Lin Tsai, Taipei City (TW); Li-Wei Chen, Taipei City (TW); Shu-Chih Kuo, Taipei City (TW)

Correspondence Address: PEARL COHEN ZEDEK, LLP, 10 ROCKEFELLER PLAZA, SUITE 1001, NEW YORK, NY, 10020, US

(73) Assignee: MAKALOT INDUSTRIAL CO., LTD

(21) Appl. No.: 11/094,294

(22) Filed: Mar. 31, 2005

(30) Foreign Application Priority Data
Jun. 30, 2004 (TW) 093119366

(51) Int. Cl. B29C 65/00; B32B 31/00

(52) U.S. Cl. 156/285; 156/60; 156/166; 156/324

(57) ABSTRACT

A method for adhering waterproof tape is provided and applied to a heating blower. The method includes the steps of: preparing a fabric and a coating that are processed to form a predetermined connecting structure; preparing a waterproof tape that is to be adhered to the connecting structure; setting operation parameters of the heating blower according to a material of the waterproof tape, to allow an operation temperature, an operation air pressure, an operation rolling pressure and an operation rotation speed of the heating blower to have optimal ranges obtained from experiments; and adhering the waterproof tape to the connecting structure by the heating blower operating with the operation temperature, operation air pressure, operation rolling pressure and operation rotation speed thereof, so as to improve an adhesion force of the waterproof tape and a blocking effect thereof against small particles and blood materials to achieve product requirements.

### FIELD OF THE INVENTION

The present invention relates to methods for adhering waterproof tapes, and more particularly, to a method for adhering waterproof tape for general textiles and special protective clothing.

### BACKGROUND OF THE INVENTION

For the textile industry, technology for seaming or adhering seams of fabrics is always important to quality, and is also critical for enhancing the competitiveness of fabric products and expanding the use thereof. For example, it has become an important issue of textile development to ensure seaming or adhering strength of seams of clothing, such that gaps or an infiltration problem of fabrics can be avoided so as to achieve market requirements of waterproofing, wind-proofing, dust-proofing, warm-keeping, and preventing small particles and liquid materials such as blood or viruses from infiltrating the fabrics.

Conventionally, in order to achieve the above requirements for fabric products, a layer of polymer coating is firstly applied on fabrics to provide a required blocking effect, and then a waterproof tape is attached to seams between the fabrics respectively, such that the waterproof tapes cover edges of the fabrics closely and are adhered to the coating applied on the fabrics, and thus pinholes produced by sewing the fabrics are well covered. Thereby, blocking and infiltration-proofing effects can be provided by the waterproof tapes on the seams. For example, in the cover-all protective clothing with a head cover as shown in FIG. 5, sleeve seams 41, sleeve side seams 42, trouser side seams 43, a neck seam 44, and other connecting positions of fabrics (not shown) are all well covered by waterproof tapes, such that gaps or infiltration at the seaming positions can be avoided to eliminate difficulty in achieving the requirements of waterproofing, wind-proofing, dust-proofing, warn-keeping, and preventing small particles and liquid materials from infiltrating the fabrics, etc.

However, for the structure described above, problems may usually occur during the manufacturing processes thereof. If the adhering process of waterproof tapes is not performed properly, or the design of the adhering process is not appropriate, not only the desired blocking effect of waterproof tapes may not be obtained, but also peeling-off of waterproof tapes or damage to the fabrics can be caused. As shown in FIG. 6A of a conventional heating blower 50 (or referred to as a hot air seam sealing machine) for adhering waterproof tapes, the heating blower 50 is provided with two rollers 30. As shown in FIG. 6B, a fabric 10 applied with a coating is placed between the two rollers 30, and then a waterproof tape 20 to be adhered to the coating is pressed onto the coating by the upper roller 30. In this step, adherence of the waterproof tape 20 to the coating is achieved by the temperature and pressure of hot air generated from a hot air nozzle 35 shown in the drawing and by control of the rolling pressure and rotation speed of the rollers 30. Such adhering process is very complicated. The adhering effect of waterproof tape may be influenced by a material of the waterproof tape, coating or fabric, a setting position of the nozzle, and operation by an operator. Particularly, the temperature and pressure of the hot air from the heating blower and the rolling pressure and rotation speed of the rollers are important parameters that influence the processing quality and directly affect the quality and yield of a final product in terms of waterproofing, wind-proofing, dust-proofing, warm-keeping and particle-proofing effects.

For a common fabric product, if the foregoing parameters are not adjusted appropriately (too high or too low in value), a problem of peeling-off or infirm adherence of the waterproof tape after washing is easy to occur especially at positions with overlapped seams or cambered bulges. Further if the parameters are not adjusted appropriately, not only failure in adherence may occur, but also melt of the fabric or coating may be caused, resulting in a waste of material.

Moreover, adjustment of the parameters also influences an infiltration-blocking characteristic of a waterproof tape after being adhered. Particularly, for a fabric product with a special protection requirement, such as protective clothing for medical use, the processing quality of adhering the waterproof tape would tremendously affect blocking and protective effects of the waterproof tape. For such product, even if a waterproof tape has been securely adhered to a coating, when parameters of the heating blower are not ideally adjusted during processing, infiltration may still occur at a seam covered by the waterproof tape, such that a desired medical effect of preventing blood, bacteria or viruses from infiltration cannot be achieved. Especially in the case of high class medical protective clothing such as that for SARS-proofing, the foregoing quality problem of waterproof tape may very possibly lead to a serious consequence to threaten personal safety of medical personnel.

Therefore, the problem to be solved here is to develop a method for adhering waterproof tape, such that parameters of a heating blower can be optimally adjusted to achieve the best quality of adherence and protection of the waterproof tape.

### SUMMARY OF THE INVENTION

In view of the forgoing drawbacks in the prior art, an objective of the present invention is to provide a method for adhering waterproof tape to enhance an adhesion force thereof.

Another objective of the present invention is to provide a method for adhering waterproof tape, which can block small particles and liquid materials.

Still another objective of the present invention is to provide a method for adhering waterproof tape, which can improve strength of a product.

A further objective of the present invention is to provide a method for adhering waterproof tape, which can improve water pressure resistance of a product.

In accordance with the above and other objectives, the present invention proposes a method for adhering waterproof tape for enhancing an adhesion force thereof, comprising the steps of: preparing a fabric and a coating that are processed to form a predetermined connecting structure; preparing a waterproof tape that is to be adhered to the connecting structure; setting operation parameters of a heating blower, such that an operation temperature thereof is between 120 to 700° C., an operation air pressure thereof is between 0.3 to 2 kg/cm², an operation rolling pressure thereof is between 1.5 to 4.5 kg/cm², and an operation rotation speed is between 100 to 400 R.P.M.; and adhering the waterproof tape to the connecting structure by the heating blower operating with the set operation temperature, operation air pressure, operation rolling pressure and operation rotation speed thereof, so as to improve an adhesion force of the waterproof tape.

Further, according to a material making a waterproof tape, the method for adhering waterproof tape for enhancing an adhesion force thereof proposed in the present invention comprises the steps of: preparing a fabric and a coating that are processed to form a predetermined connecting structure; preparing a waterproof tape made of any one of nylon, PVC (polyvinyl chloride), PU (polyurethane) and PE (polyethylene); setting operation parameters of a heating blower, such that an operation temperature, an operation air pressure, an operation rolling pressure and an operation rotation speed of the heating blower are between 350 to 600° C., 0.3 to 2 kg/cm², 3 to 4 kg/cm², and 100 to 300 R.P.M. respectively if the waterproof tape is made of nylon; the operation temperature, operation air pressure, operation rolling pressure and operation rotation speed of the heating blower are between 450 to 600° C., 0.3 to 2 kg/cm², 2 to 2.5 kg/cm², and 150 to 300 R.P.M. respectively if the waterproof tape is made of PVC; the operation temperature, operation air pressure, operation rolling pressure and operation rotation speed of the heating blower are between 350 to 600° C., 0.3 to 2 kg/cm², 2 to 2.5 kg/cm², and 150 to 300 R.P.M. respectively if the waterproof tape is made of PU; or the operation temperature, operation air pressure, operation rolling pressure and operation rotation speed of the heating blower are between 120 to 400° C., 0.3 to 2 kg/cm², 2 to 4 kg/cm², and 100 to 300 R.P.M. respectively if the waterproof tape is made of PE; and adhering the waterproof tape to the connecting structure by the heating blower operating with the set operation temperature, operation air pressure, operation rolling pressure and operation rotation speed thereof so as to improve an adhesion force of the waterproof tape.

Moreover, the present invention provides a method for adhering waterproof tape for blocking small particles and liquid materials, comprising the steps of: preparing a fabric and a coating that are processed to form a predetermined connecting structure; preparing a waterproof tape that is to be adhered to the connecting structure; setting operation parameters of a heating blower, such that an operation temperature thereof is between 200 to 600° C., an operation air pressure thereof is between 0.5 to 0.9 kg/cm², an operation rolling pressure thereof is between 2 to 4.5 kg/cm², and an operation rotation speed thereof is between 100 to 350 R.P.M.; and adhering the waterproof tape to the connecting structure by the heating blower operating with the set operation temperature, operation air pressure, operation rolling pressure and operation rotation speed thereof so as to improve a blocking effect of the waterproof tape against small particles and liquid materials.

Further, according to a material making a waterproof tape, the method for adhering waterproof tape proposed in the present invention for blocking small particles and liquid materials, comprises the steps of: preparing a fabric and a coating that are processed to form a predetermined connecting structure; preparing a waterproof tape made of any one of nylon, PVC, PU and PE; setting operation parameters of a heating blower, such that an operation temperature, an operation air pressure, an operation rolling pressure and an operation rotation speed of the heating blower are between 460 to 510° C., 0.5 to 0.9 kg/cm², 3 to 4 kg/cm², and 200 to 250 R.P.M. respectively if the waterproof tape is made of nylon; the operation temperature, operation air pressure, operation rolling pressure and operation rotation speed of the heating blower are between 500 to 550° C., 0.5 to 0.9 kg/cm², 1.5 to 2.5 kg/cm², and 200 to 300 R.P.M. respectively if the waterproof tape is made of PVC; the operation temperature, operation air pressure, operation rolling pressure and operation rotation speed of the heating blower are between 500 to 540° C., 0.5 to 0.9 kg/cm², 2 to 2.2 kg/cm², and 200 to 300 R.P.M. respectively if the waterproof tape is made of PU; or the operation temperature, operation air pressure, operation rolling pressure and operation rotation speed of the heating blower are between 250 to 400° C., 0.5 to 0.9 kg/cm², 3 to 4 kg/cm², and 250 to 300 R.P.M. respectively if the waterproof tape is made of PE; and adhering the waterproof tape to the connecting structure by the heating blower operating with the set operation temperature, operation air pressure, operation rolling pressure and operation rotation speed thereof so as to improve a blocking effect of the waterproof tape against small particles and liquid materials.

Moreover, apart from selecting the operation parameters of the heating blower according to the material making the waterproof tape, the operation parameters of the heating blower can be adjusted depending on a thickness and melting point of the waterproof tape according to the method for adhering waterproof tape proposed in the present invention. In such case, the method comprises the steps of: preparing a fabric and a coating that are processed to form a predetermined connecting structure; preparing a waterproof tape that is to be adhered to the connecting structure; setting operation parameters of a heating blower to determine whether an operation rolling pressure of the heating blower is set to be larger than a predetermined rolling pressure depending on whether a combined thickness of the waterproof tape and the connecting structure is larger than a predetermined thickness, and to determine whether an operation temperature, an operation air pressure and an operation rotation speed of the heating blower are set to be respectively larger than a predetermined temperature, a predetermined air pressure and a predetermined rotation speed depending on whether a melting point of the waterproof tape is larger than a predetermined melting point; and adhering the waterproof tape to the connecting structure by the heating blower operating with the set operation temperature, operation air pressure, operation rolling pressure and operation rotation speed thereof.

Therefore, by the foregoing method for adhering waterproof tape according to the present invention, an adhering process of a waterproof tape can be performed with the most appropriate parameters of a heating blower based on a material, thickness and melting point of the waterproof tape, such that the adhering quality of the waterproof tape can be improved and an effect for effectively blocking small particles and liquid materials can be achieved, thereby accomplishing various requirements for textiles, such as waterproofing, wind-proofing, dust-proofing, warm-keeping, and infiltration-proofing for medical use, etc. in the market.

### BRIEF DESCRIPTION OF THE DRAWINGS

The present invention can be more fully understood by reading the following detailed description of the preferred embodiments, with reference made to the accompanying drawings, wherein:

FIG. 1 is an operation procedure flowchart showing a method for adhering waterproof tape according to the present invention;

FIGS. 2A to 2C are schematic diagrams of various types of structure after adhering a waterproof tape to a connecting structure;

FIG. 3A is a schematic diagram showing parameter adjustment for improving an adhesion force of a waterproof tape according to the present invention;

FIG. 3B is a detailed flowchart showing parameter adjustment for improving the adhesion force of the waterproof tape made of various materials according to the present invention;

FIG. 4A is a schematic diagram showing parameter adjustment for blocking small particles and liquid materials according to the present invention;

FIG. 4B is a detailed flowchart showing parameter adjustment for blocking small particles and liquid materials by a waterproof tape made of various materials according to the present invention;

FIG. 5 (PRIOR ART) is a schematic diagram showing positions of conventional clothing adhered with waterproof tapes; and

FIGS. 6A and 6B (PRIOR ART) are schematic diagrams showing conventional heating blower for adhering a waterproof tape.

### DETAILED DESCRIPTION OF THE PREFERRED EMBODIMENTS

A method for adhering waterproof tape proposed in the present invention is used to improve an adhesion force of the waterproof tape, and thereby enhance a blocking effect of the waterproof tape against small particles and liquid materials such as blood and viruses, so as to solve problems in a conventional adhering process. Preferred embodiments of the present invention are described as follows.

Improving Adhesion Force of Waterproof Tape

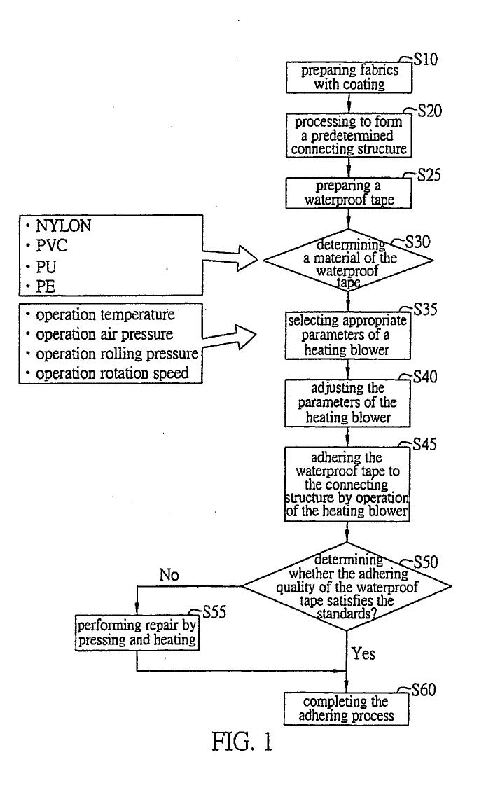

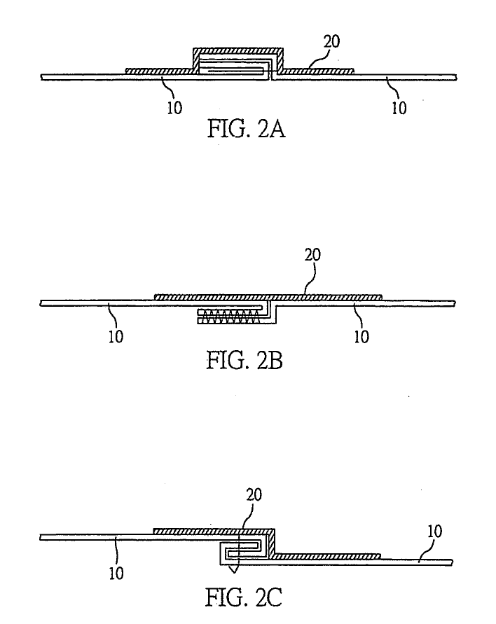

FIG. 1 is a flowchart showing steps of the method for adhering waterproof tape according to the present invention. As shown in FIG. 1, firstly, in step S10, fabrics with a coating applied on a surface thereof respectively (alternatively, the coating can be applied and formed in the fabrics) are prepared. The fabric is made of a material selected according to the purpose of a final product, and the coating for enhancing a blocking effect of the fabric can be made of a polymer material such as nylon, PU, PVC, PE, or TPU (thermoplastic polyurethane), etc. Then, in step S20, the fabrics are processed at seam positions to form a predetermined connecting structure. The connecting structure may be one of the examples shown in FIGS. 2A to 2C. For example, when the coating (not shown) is applied on an inner surface of each of the fabrics 10, the connecting structure may be formed as a lock-stitch structure shown in FIG. 2A; if the coating (not shown) is applied on an outer surface of each of the fabrics 10, the connecting structure may be formed as an over-lock structure shown in FIG. 2B or an overcast structure shown in FIG. 2C. The connecting structure may be designed to be other structures such as a melting seam structure (not shown) according to requirements of a user.

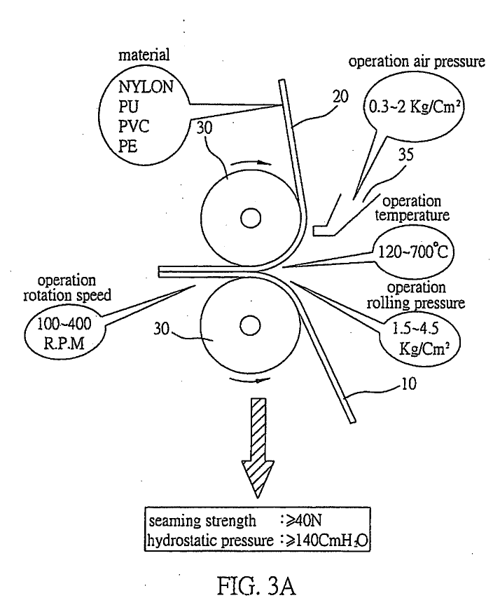

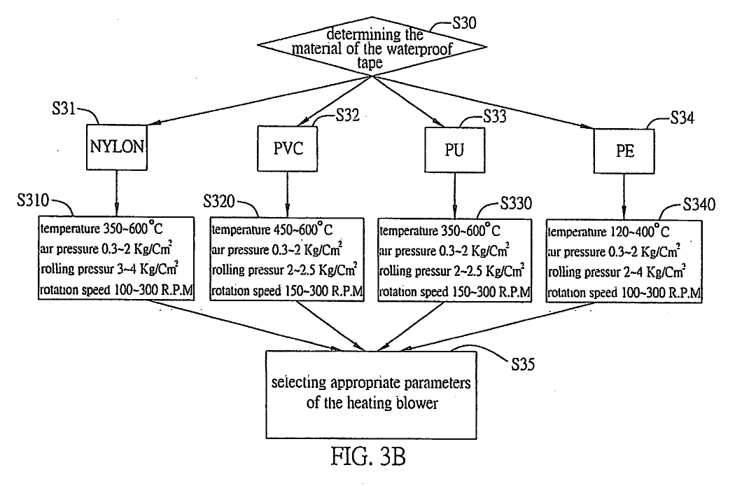

Next, in step S25, a waterproof tape 20 that is to be adhered to the connecting structure is prepared. The waterproof tape 20 can be made of a polymer material such as nylon, PU, PVC, or PE, etc. Generally, the waterproof tape 20 may be made of the same material as the coating. Then, in steps S30 and S35, appropriate parameters of a heating blower are selected according to the material of the waterproof tape 20. As shown in FIG. 3A, to set the parameters of the heating blower for improving the adhesion force of the waterproof tape according to the present invention, in step S40, before operation of the heating blower, an operation temperature thereof is adjusted to be between 120 to 700° C., an operation air pressure thereof is adjusted to be between 0.3 to 2 kg/cm², an operation rolling pressure thereof is adjusted to be between 1.5 to 4.5 kg/cm², and an operation rotation speed thereof is adjusted to be between 100 to 400 R.P.M. Subsequently, in step S45, the heating blower operates with the above parameters to make the waterproof tape adhered to the connecting structure and cover the seam positions.

By the adhering process performed with the foregoing parameters, the waterproof tape can be securely adhered to the connecting structure without peeling off therefrom, thereby satisfying standards of seaming strength and hydrostatic pressure set up by CNS (Chinese National Standard). In other words, the seaming strength of every connecting structure adhered with the waterproof tape is greater than 40N, and the measured hydrostatic pressure thereof is higher than 140 cmH₂O, as shown in FIG. 3A, wherein the seaming strength refers to a force required for stretching and breaking the seam positions of the fabrics, and the hydrostatic pressure refers to a pressure required for making water penetrate the fabrics at a predetermined speed.

Moreover, after completely adhering the waterproof tape, the method for adhering waterproof tape according to the present invention further includes a determining step shown as step S50 in FIG. 1 to determine whether the adhering quality of the waterproof tape satisfies the standards, for example, determining whether the seaming strength or any other strength thereof is sufficient. If yes, then step S60 is carried out to complete the adhering process. If no, then step S55 is carried out to repair the waterproof tape and the connecting structure by a repairing machine so as to reinforce the adhesion strength of the waterproof tape by performing a pressing or heating process for a predetermined period of time and subsequently step S60 is carried out after the requirement has been fulfilled, to complete the adhering process for the waterproof tape according to the present invention.

In the forgoing method, the required parameters of the heating blower are determined by steps S30 and S35, and the adhering quality of the waterproof tape, which can not be assured by the conventional technology, can be achieved by operation being performed with the determined parameters. Moreover, the parameters of the heating blower can further be determined and adjusted corresponding to the material of the waterproof tape by steps S30 and S35, as shown in FIG. 3B. If the material of the waterproof tape is nylon (step S31), the operation temperature, operation air pressure, operation rolling pressure and operation rotation speed of the heating blower are adjusted to be between 350 to 600° C., 0.3 to 2 kg/cm², 3 to 4 kg/cm², and 100 to 300 R.P.M. respectively in step S310. If the material of the waterproof tape is PVC (step S32), the operation temperature, operation air pressure, operation rolling pressure and operation rotation speed of the heating blower are adjusted to be between 450 to 600° C., 0.3 to 2 kg/cm², 2 to 2.5 kg/cm², and 150 to 300 R.P.M. respectively in step S320. If the material of the waterproof tape is PU (step S33), the operation temperature, operation air pressure, operation rolling pressure and operation rotation speed of the heating blower are adjusted to be between 350 to 600° C., 0.3 to 2 kg/cm², 2 to 2.5 kg/cm², and 150 to 300 R.P.M. respectively in step S330. Finally, if the material of the waterproof tape is PE (step S34), the operation temperature, operation air pressure, operation rolling pressure and operation rotation speed of the heating blower are adjusted to be between 120 to 400° C., 0.3 to 2 kg/cm², 2 to 4 kg/cm², and 100 to 300 R.P.M. respectively in step S340. With these parameters set for different materials of the waterproof tape, the required testing standards, i.e. the seaming strength being greater than 40N and the hydrostatic pressure being higher than 140 cmH₂O, can be satisfied for all these materials, and the adhesion strength of the waterproof tape can be effectively improved.

### EXAMPLE 1

The following table shows testing results of using nylon as the material of the waterproof tape. From this table, it indicates that all the adhering processes, which were performed within the foregoing ranges of parameters, passed in an adhesion test for the waterproof tape, wherein the standards for determining whether the waterproof tape is adhered securely are the same as those described above, i.e. whether the seaming strength is greater than 40N after adherence and the hydrostatic pressure is higher than 140 cmH₂O.

TABLE 1

| | Operation parameters of heating blower | | | | Whether |
|---|---|---|---|---|---|
| | Operation | Operation | Operation | operation | waterproof |
| Material of | temper- | air | rolling | rotation | tape is |
| waterproof | ature | pressure | pressure | speed | adhered |
| tape | (° C.) | (kg/cm²) | (kg/cm²) | (R.P.M.) | securely? |
| nylon | 600 | 0.8 | 4 | 300 | YES |
| nylon | 580 | 0.8 | 4 | 280 | YES |
| nylon | 550 | 0.8 | 4 | 250 | YES |
| nylon | 500 | 0.8 | 4 | 230 | YES |
| nylon | 480 | 0.8 | 4 | 220 | YES |
| nylon | 450 | 0.8 | 4 | 200 | YES |
| nylon | 400 | 0.8 | 3 | 150 | YES |
| nylon | 350 | 0.8 | 3 | 100 | YES |

### EXAMPLE 2

The following table shows testing results of using PE as the material of the waterproof tape. From this table, it indicates that all the adhering processes, which were performed within the foregoing ranges of parameters, passed in the adhesion test for the waterproof tape, wherein the standards for determining whether the waterproof tape is adhered securely are the same as those described above, i.e. whether the seaming strength is greater than 40N after adherence and the hydrostatic pressure is higher than 140 cmH₂O.

TABLE 2

| | Operation parameters of heating blower | | | | Whether |
|---|---|---|---|---|---|
| | Operation | Operation | Operation | Operation | waterproof |
| Material of | temper- | air | rolling | rotation | tape is |
| waterproof | ature | pressure | pressure | speed | adhered |
| tape | (° C.) | (kg/cm²) | (kg/cm²) | (R.P.M.) | securely? |
| PE | 350 | 0.6 | 3 | 300 | YES |
| PE | 300 | 0.6 | 3 | 250 | YES |
| PE | 260 | 0.6 | 3 | 200 | YES |
| PE | 230 | 0.6 | 3 | 180 | YES |
| PE | 200 | 0.6 | 2.8 | 150 | YES |
| PE | 150 | 0.6 | 2.5 | 130 | YES |
| PE | 130 | 0.6 | 2 | 100 | YES |
| PE | 120 | 0.6 | 2 | 90 | YES |

### EXAMPLE 3

The following table shows testing results of using PU as the material of the waterproof tape. From this table, it indicates that all the adhering processes, which were performed within the foregoing ranges of parameters, passed in the adhesion test for the waterproof tape, wherein the standards for determining whether the waterproof tape is adhered securely are the same as those described above, i.e. whether the seaming strength is greater than 40N after adherence and the hydrostatic pressure is higher than 140 cmH₂O.

TABLE 3

| | Operation parameters of heating blower | | | | Whether |
|---|---|---|---|---|---|
| | Operation | Operation | Operation | Operation | waterproof |
| Material of | temper- | air | rolling | rotation | tape is |
| waterproof | ature | pressure | pressure | speed | adhered |
| tape | (° C.) | (kg/cm²) | (kg/cm²) | (R.P.M.) | securely? |
| PU | 600 | 0.8 | 2.5 | 300 | YES |
| PU | 550 | 0.8 | 2.5 | 280 | YES |
| PU | 540 | 0.8 | 2.2 | 250 | YES |
| PU | 500 | 0.8 | 2 | 250 | YES |
| PU | 450 | 0.8 | 2 | 200 | YES |
| PU | 400 | 0.8 | 2 | 180 | YES |
| PU | 350 | 0.8 | 2 | 150 | YES |

### EXAMPLE 4

The following table shows testing results of using PVC as the material of the waterproof tape. From this table, it indicates that all the adhering processes, which were performed within the foregoing ranges of parameters, passed in the adhesion test for the waterproof tape, wherein the standards for determining whether the waterproof tape is adhered securely are the same as those described above, i.e. whether the seaming strength is greater than 40N after adherence and the hydrostatic pressure is higher than 140 cmH₂O.

TABLE 4

| | Operation parameters of heating blower | | | | Whether |
|---|---|---|---|---|---|
| | Operation | Operation | Operation | Operation | waterproof |
| Material of | temper- | air | rolling | rotation | tape is |
| waterproof | ature | pressure | pressure | speed | adhered |
| tape | (° C.) | (kg/cm²) | (kg/cm²) | (R.P.M.) | securely? |
| PVC | 600 | 0.8 | 2.5 | 300 | YES |
| PVC | 550 | 0.8 | 2 | 250 | YES |
| PVC | 500 | 0.8 | 2 | 230 | YES |
| PVC | 450 | 0.8 | 2 | 200 | YES |

Blocking Small Particles and Liquid Materials

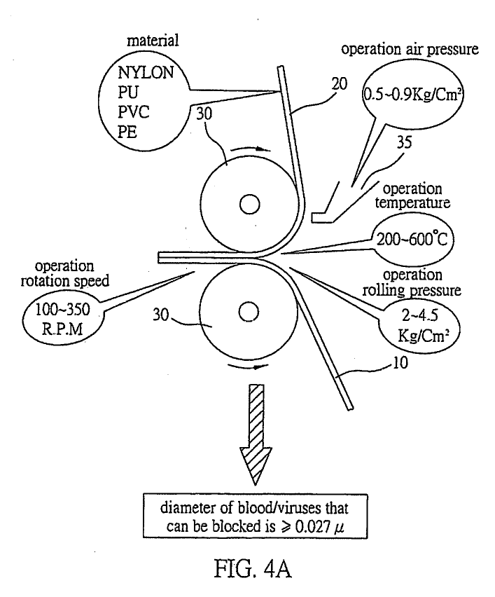

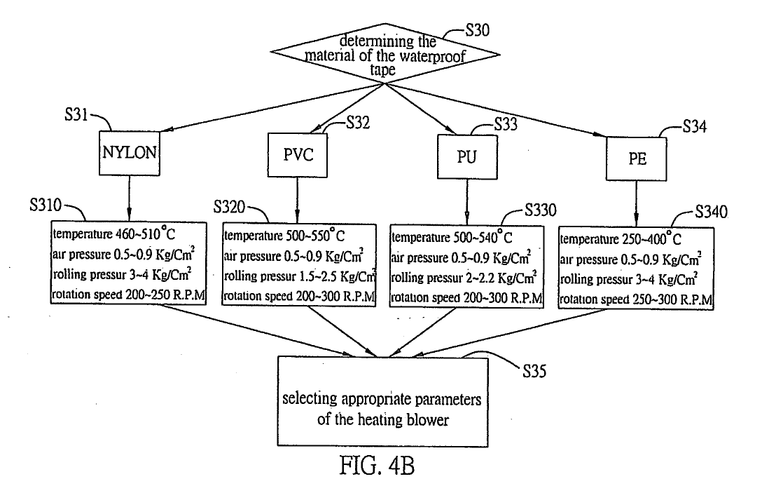

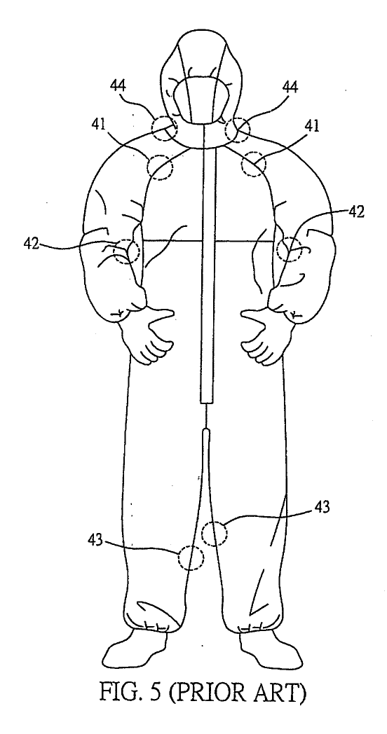

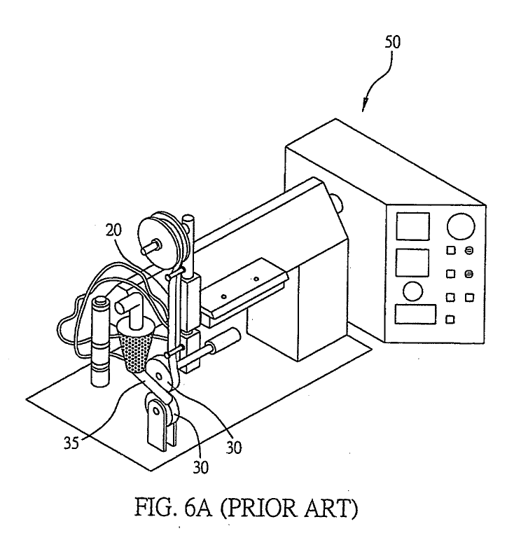

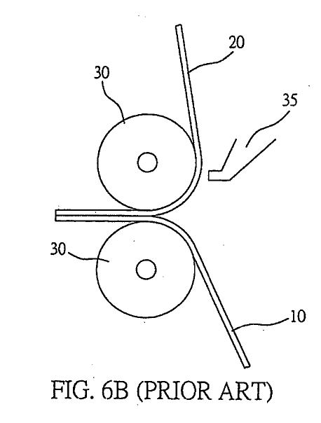

Additionally, for a blocking requirement of medical textiles, in the method for adhering waterproof tape according to the present invention as shown in the flowchart of FIG. 1, a smaller range for parameter adjustment is proposed in step S35, such that the waterproof tape can block small particles and liquid materials such as blood or viruses after being adhered to the connecting structure. As shown in FIG. 4A, before operation of the heating blower, the operation temperature thereof is adjusted to be between 200 to 600° C., the operation air pressure thereof is adjusted to be between 0.5 to 0.9 kg/cm², the operation rolling pressure thereof is adjusted to be between 2 to 4.5 kg/cm², and the operation rotation speed thereof is adjusted to be between 100 to 350 R.P.M. Next, in step S45, the heating blower operates with the above parameters to make the waterproof tape adhered to the connecting structure and cover the seam positions.

Thereby, blood and viruses can be indeed prevented from infiltrating the fabrics by the waterproof tape adhered to the seam positions, and thus standards of penetrability for viruses set up by CNS can be satisfied to sufficiently block bacteriophage Phi-X174 having a diameter of 0.027 μm and prevent the small particles and liquid materials from entering the fabrics. Of course, viruses generally with a diameter about 0.08 μm, bacteria generally with a diameter between 0.25 to 1.5 μm, and corpuscles in blood with an even larger diameter can all be blocked by the waterproof tape, thereby achieving a medical protection effect for medical textiles, and satisfying requirements for medical protective clothing such as that for SARS-resistance.

In the foregoing method, the required parameters of the heating blower are determined by steps S30 and S35 in FIG. 1, and thus the effect of blocking small particles and liquid materials, which cannot be assured by the conventional technology, can be achieved by processing being performed with the determined parameters. Moreover, in steps S30 and S35, the parameters of the heating blower can be further determined according to the material of the waterproof tape, as shown in the flowchart of FIG. 4B. If the waterproof tape is made of nylon (step S31), the operation temperature, operation air pressure, operation rolling pressure and operation rotation speed of the heating blower can be adjusted to be between 460 to 510° C., 0.5 to 0.9 kg/cm², 3 to 4 kg/cm², and 200 to 250 R.P.M. respectively in step S310. If the waterproof tape is made of PVC (step S32), the operation temperature, operation air pressure, operation rolling pressure and operation rotation speed of the heating blower can be adjusted to be between 500 to 550° C., 0.5 to 0.9 kg/cm², 1.5 to 2.5 kg/cm², and 200 to 300 R.P.M. respectively in step S320. If the waterproof tape is made of PU (step S33), the operation temperature, operation air pressure, operation rolling pressure and operation rotation speed of the heating blower can be adjusted to be between 500 to 540° C., 0.5 to 0.9 kg/cm², 2 to 2.2 kg/cm², and 200 to 300 R.P.M. respectively in step S330. Finally, if the waterproof tape is made of PE (step S34), the operation temperature, operation air pressure, operation rolling pressure and operation rotation speed of the heating blower can be adjusted to be between 250 to 400° C., 0.5 to 0.9 kg/cm², 3 to 4 kg/cm², and 250 to 300 R.P.M. respectively in step S340. With these parameters set for different materials of the waterproof tape, the foregoing requirement can also be satisfied, i.e. blocking filtration of bacteriophage Phi-X174 with a diameter of 0.027 μm, and the blocking effect of the waterproof tape after adherence can be effectively improved.

### EXAMPLE 5

The following table shows testing results of using PVC, PU, nylon and PE as the material of the waterproof tape respectively. From this table, it indicates that all the adhering processes, which were performed within the foregoing ranges of parameters, passed in the virus penetrability test for the waterproof tape, wherein the standard for determining whether the waterproof tape can indeed block virus particles is the same as that described above, i.e. whether bacteriophage Phi-X174 with a diameter of 0.027 μm can be blocked from infiltration.

TABLE 5

| | Operation parameters of heating blower | | | | Whether |
|---|---|---|---|---|---|
| Material | Operation | Operation | Operation | Operation | virus |
| of | temper- | air | rolling | rotation | particals are |
| waterproof | ature | pressure | pressure | speed | indeed |
| tape | (° C.) | (kg/cm²) | (kg/cm²) | (R.P.M.) | blocked? |
| PVC | 550 | 0.8 | 2 | 250 | YES |
| PU | 540 | 0.8 | 2.2 | 250 | YES |
| PU | 500 | 0.8 | 2 | 250 | YES |
| nylon | 510 | 0.8 | 3 | 250 | YES |
| nylon | 480 | 0.8 | 4 | 250 | YES |
| nylon | 460 | 0.8 | 3.8 | 200 | YES |
| PE | 300 | 0.8 | 3 | 250 | YES |
| PE | 250 | 0.8 | 4 | 250 | YES |

### EXAMPLE 6

The following table shows testing results of a CNS test performed with the foregoing parameters, wherein the testing object in this table is a structure adhered with a waterproof tape made of PE, with an operation temperature of 300° C., an operation air pressure of 0.6 kg/cm², an operation rolling pressure of 3 kg/cm², and an operation rotation speed of 250 R.P.M.

In the table, blood infiltration refers to a blocking capability test of textile against synthetic blood. Virus infiltration refers to a blocking capability test of textile against bacteriophage Phi-X174. Protection efficiency refers to a percentage of known suspended particles not able to pass through a textile under a certain flow rate. Longitudinal and transverse breaking strength refers to a force required for stretching and breaking the textile in different directions. Exploding strength refers to a force required for expanding and breaking the textile. Seaming strength refers to a force required for stretching and breaking a seam of the textile. Longitudinal and transverse tearing strength refers to a force required for tearing or continuously tearing the textile. Water permeability refers to the mass of steam passing through the textile within 24 hours. Hydrostatic pressure refers to a pressure required for making water penetrate the textile at a certain speed. Impact permeability refers to a quantity of water permeating the textile after swashing the textile with a certain quantity of water.

TABLE 6

| | Operation parameters of heating blower | | | |
|---|---|---|---|---|
| | | Operation | | |
| Material of | Operation | air | Operation | Operation |
| waterproof | temperature | pressure | rolling pressure | rotation speed |
| tape | (° C.) | (kg/cm²) | (kg/cm²) | (R.P.M.) |
| PE | 300 | 0.6 | 3 | 250 |

| Testing item | Testing result | Target value |
|---|---|---|
| blood infiltration | None | None |
| virus infiltration | None | None |
| protection efficiency | 100% | 95% |
| longitudinal breaking | 150.4 N | 50 N |
| strength | | |
| transverse breaking strength | 123.3 N | 40 N |
| exploding strength | 551.6 kPa | 200 kPa |
| seaming strength | 128.8 N | 40 N |
| longitudinal tearing strength | 73.2 N | 20 N |
| transverse tearing strength | 98.7 N | 20 N |
| water permeability | 4578 g/m²/24 hrs | 2500 g/m²/24 hrs |
| hydrostatic pressure | >180 cmH₂O | 140 cmH₂O |
| impact permeability | 0 g | 0.5 g |

Thus, according to the testing results shown in the above table, it clearly indicates that, based on the waterproof tape being adhered under the parameters of the heating blower proposed in the present invention, the adhering quality can truly be improved significantly to achieve results much higher than the CNS testing target values (with respect to for example one-time usable textiles such as one-time usable protective clothing as a standard).

### EXAMPLE 7

The following table shows testing results of another CNS test performed with the foregoing parameters, wherein the testing object in this table is a structure adhered with a waterproof tape made of nylon, under an operation temperature of 480° C., an operation air pressure of 0.8 kg/cm², an operation rolling pressure of 4 kg/cm², and an operation rotation speed of 250 R.P.M.

TABLE 7

| | Operation parameters of heating blower | | | |
|---|---|---|---|---|
| | | | | Operation |
| | Operation | Operation air | Operation | rotation |
| Material of | temperature | pressure | rolling pressure | speed |
| waterproof tape | (° C.) | (kg/cm²) | (kg/cm²) | (R.P.M.) |
| nylon | 480 | 0.8 | 4 | 250 |

| Testing item | Testing result | Target value |
|---|---|---|
| blood infiltration | None | None |
| virus infiltration | None | None |
| protection efficiency | 100% | 95% |
| longitudinal breaking | 652.7 N | 200 N |
| strength | | |
| transverse breaking strength | 467.2 N | 200 N |
| exploding strength | 1333 kPa | 200 kPa |
| seaming strength | 469.6 N | 40 N |
| longitudinal tearing strength | 180.8 N | 20 N |
| transverse tearing strength | 310.7 N | 20 N |
| water permeability | 1817 g/m²/24 hrs | 1500 g/m²/24 hrs |
| hydrostatic pressure | >180 cmH₂O | 140 cmH₂O |
| impact permeability | 0 g | 0.5 g |

Thus, according to the testing results shown in the above table, it clearly indicates that, based on the waterproof tape being adhered under the parameters of the heating blower proposed in the present invention, the adhering quality can truly be improved significantly to achieve results much higher than the CNS testing target values (with reference to for example multi-times usable textiles such as multi-times usable protective clothing as a standard).

In each of the foregoing embodiments for the method for adhering waterproof tape according to the present invention, the adhering process of waterproof tape is performed by adjusting the ranges of parameters of the heating blower depending on the material of a waterproof tape that is to be adhered, so as to improve the adhesion strength of the waterproof tape and enhance a blocking effect of the waterproof tape against small particles and liquid materials. However, the present invention is not limited to utilizing the material of waterproof tape as a basis for adjusting the parameters. If the thickness and melting point of the waterproof tape and the thickness of the connecting structure can be measured in advance, the above adjusted ranges of parameters of the heating blower can further be adjusted optimally according to the measured thickness and melting point.

According to the present invention, for the parameters of the heating blower, the optimal operation rolling pressure for enhancing the adhesion strength of the waterproof tape and the blocking effect thereof against small particles and liquid materials is positively proportional to the combined thickness of the waterproof tape and the connecting structure. In other words, the larger the combined thickness of the waterproof tape and the connecting structure, the higher the required optimal operation rolling pressure is. In addition, the optimal operation temperature, operation air pressure and operation rotation speed of the heating blower are also positively proportional to the melting point of the waterproof tape. Therefore, the higher the melting point of the waterproof tape, the higher the optimal operation temperature, operation air pressure and operation rotation speed should be adjusted. The required adhering quality can be achieved by making corresponding adjustment according to the ranges of parameters proposed in the present invention.

Therefore, by the method for adhering waterproof tape in the present invention, the adhering quality of the waterproof tape can be improved and the blocking effect thereof against small particles and liquid materials can be achieved to increase the strength of textiles, such that the present invention can be applied to clothing and other textile products to satisfy various requirements of waterproofing, wind-proofing, dust-proofing, warm-keeping, and medical infiltration-proofing, etc. in the market.

The invention has been described using exemplary preferred embodiments. However, it is to be understood that the scope of the present invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for adhering waterproof tape, applied to a heating blower, the method comprising the steps of:
preparing a fabric and a coating that are processed to form a predetermined connecting structure;
preparing a waterproof tape that is to be adhered to the connecting structure;
setting operation parameters of the heating blower, such that an operation temperature thereof is between 120 to 700° C., an operation air pressure thereof is between 0.3 to 2 kg/cm², an operation rolling pressure thereof is between 1.5 to 4.5 kg/cm², and an operation rotation speed thereof is between 100 to 400 R.P.M.; and
adhering the waterproof tape to the connecting structure by the heating blower operating with the set operation temperature, operation air pressure, operation rolling pressure and operation rotation speed thereof so as to improve an adhesion force of the waterproof tape.

2. The method for adhering waterproof tape of claim 1, wherein the waterproof tape is made of a material selected from the group consisting of nylon, PVC (polyvinyl chloride), PU (polyurethane) and PE (polyethylene).

3. The method for adhering waterproof tape of claim 2, wherein if the waterproof tape is made of nylon, the operation temperature, operation air pressure, operation rolling pressure and operation rotation speed of the heating blower are between 350 to 600° C., 0.3 to 2 kg/cm², 0.3 to 4 kg/cm², and 100 to 300 R.P.M. respectively.

4. The method for adhering waterproof tape of claim 2, wherein if the waterproof tape is made of PVC, the operation temperature, operation air pressure, operation rolling pressure and operation rotation speed of the heating blower are between 450 to 600° C., 0.3 to 2 kg/cm², 2 to 2.5 kg/cm², and 150 to 300 R.P.M. respectively.

5. The method for adhering waterproof tape of claim 2, wherein if the waterproof tape is made of PU, the operation temperature, operation air pressure, operation rolling pressure and operation rotation speed of the heating blower are between 350 to 600° C., 0.3 to 2 kg/cm², 2 to 2.5 kg/cm², and 150 to 300 R.P.M. respectively.

6. The method for adhering waterproof tape of claim 2, wherein if the waterproof tape is made of PE, the operation temperature, operation air pressure, operation rolling pressure and operation rotation speed of the heating blower are between 120 to 400° C., 0.3 to 2 kg/cm², 2 to 4 kg/cm², and 100 to 300 R.P.M. respectively.

7. The method for adhering waterproof tape of claim 1, wherein improving the adhesion force of the waterproof tape refers to allowing seaming strength of the connecting structure to be greater than 40N and the hydrostatic pressure of the connecting structure to be higher than 140 cmH₂O.

8. The method for adhering waterproof tape of claim 1, further comprising pressing and heating the waterproof tape and the connecting structure by a repairing machine after adhering the waterproof tape to the connecting structure.

9. The method for adhering waterproof tape of claim 1, wherein the connecting structure comprises a lock-stitch structure, over-lock structure, overcast structure, or melting seam structure.

10. A method for adhering waterproof tape, applied to a heating blower, the method comprising the steps of:
preparing a fabric and a coating that are processed to form a predetermined connecting structure;
preparing a waterproof tape that is to be adhered to the connecting structure;
setting operation parameters of the heating blower, such that an operation temperature thereof is between 200 to 600° C., an operation air pressure thereof is between 0.5 to 0.9 kg/cm², an operation rolling pressure thereof is between 2 to 4.5 kg/cm², and an operation rotation speed thereof is between 100 to 350 R.P.M.; and
adhering the waterproof tape to the connecting structure by the heating blower operating with the set operation temperature, operation air pressure, operation rolling pressure and operation rotation speed thereof so as to improve a blocking effect of the waterproof tape against small particles and liquid materials.

11. The method for adhering waterproof tape of claim 10, wherein the waterproof tape is made of a material selected from the group consisting of nylon, PVC, PU and PE.

12. The method for adhering waterproof tape of claim 11, wherein if the waterproof tape is made of nylon, the operation temperature, operation air pressure, operation rolling pressure and operation rotation speed of the heating blower are between 460 to 510° C., 0.5 to 0.9 kg/cm², 3 to 4 kg/cm², and 200 to 250 R.P.M. respectively.

13. The method for adhering waterproof tape of claim 11, wherein if the waterproof tape is made of PVC, the operation temperature, operation air pressure, operation rolling pressure and operation rotation speed of the heating blower are between 500 to 550° C., 0.5 to 0.9 kg/cm², 1.5 to 2.5 kg/cm², and 200 to 300 R.P.M. respectively.

14. The method for adhering waterproof tape of claim 11, wherein if the waterproof tape is made of PU, the operation temperature, operation air pressure, operation rolling pressure and operation rotation speed of the heating blower are between 500 to 540° C., 0.5 to 0.9 kg/cm², 2 to 2.2 kg/cm², and 200 to 300 R.P.M. respectively.

15. The method for adhering waterproof tape of claim 11, wherein if the waterproof tape is made of PE, the operation temperature, operation air pressure, operation rolling pressure and operation rotation speed of the heating blower are between 250 to 400° C., 0.5 to 0.9 kg/cm², 3 to 4 kg/cm², and 250 to 300 R.P.M. respectively.

16. The method for adhering waterproof tape of claim 10, wherein improving the blocking effect of the waterproof tape against small particles and liquid materials refers to allowing the waterproof tape and the connecting structure to be capable of blocking viruses with a diameter of 0.027 μm.

17. The method for adhering waterproof tape of claim 10, further comprising pressing and heating the waterproof tape and the connecting structure by a repairing machine after adhering the waterproof tape to the connecting structure.

18. The method for adhering waterproof tape of claim 10, wherein the connecting structure comprises a lock-stitch structure, over-lock structure, overcast structure, or melting seam structure.

19. A method for adhering waterproof tape, applied to a heating blower, the method comprising the steps of:
preparing a fabric and a coating that are processed to form a predetermined connecting structure;
preparing a waterproof tape that is to be adhered to the connecting structure;
setting operation parameters of the heating blower so as to determine whether an operation rolling pressure of the heating blower is set to be larger than a predetermined rolling pressure depending on whether a combined thickness of the waterproof tape and the connecting structure is larger than a predetermined thickness, and determine whether an operation temperature, an operation air pressure and an operation rotation speed of the heating blower are set to be respectively larger than a predetermined temperature, a predetermined air pressure and a predetermined rotation speed depending on whether a melting point of the waterproof tape is larger than a predetermined melting point; and
adhering the waterproof tape to the connecting structure by the heating blower operating with the set operation temperature, operation air pressure, operation rolling pressure and operation rotation speed thereof.

20. The method for adhering waterproof tape of claim 19, wherein the waterproof tape is made of a material selected from the group consisting of nylon, PVC, PU and PE.

21. The method for adhering waterproof tape of claim 19, further comprising pressing and heating the waterproof tape and the connecting structure by a repairing machine after adhering the waterproof tape to the connecting structure.

22. The method for adhering waterproof tape of claim 19, wherein the connecting structure comprises a lock-stitch structure, over-lock structure, overcast structure, or melting seam structure.
